(19) United States
(12) Patent Application Publication
(10) Pub. No.: US 2008/0240885 A1
(43) Pub. Date: Oct. 2, 2008

(54) Nail

(76) Inventors: Ching-Guei Lin, Lujhu Township (TW); Mau-Chang Wu, Lujhu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,663

(22) Filed: Mar. 28, 2007

(51) Int. Cl. F16B 15/00; A43B 23/20

(52) U.S. Cl. 411/446; 411/439

(57) ABSTRACT

A nail comprises a plurality of umbrella-shaped threads spirally formed on the shank and extended from the nail end to the head, wherein the umbrella-shaped thread includes a top face and an end edge face, in which the outer diameter of the top face is greater than the outer diameter of the end edge face, such that the nail can be nailed into a planking easily and successfully without the obstacle of the umbrella-shaped threads. While pulling out the nail, an actuating tool is used directly to rotate back the nail, so as to prevent from damaging the surface of the planking and efficiently save the time and labor.

### BACKGROUND OF THE INVENTION

1. Field of the Invention

The present invention generally relates to a fastener, and in particular a nail that can prevent from damaging the surface of the planking and save the time and labor while in operating.

2. Description of the Related Art

Referring to FIG. 1, a conventional nail comprises a head 11 with an recess 111 formed on the upper surface of the head 11, a shank 12 connected to the head 11 and defining a nail end 121 at a free end of the shank 12, a thread 13 spirally formed on the shank 12 closed to the head 11, a plurality of cutting grooves 131 formed on the threads 13 to section the threads 13.

While using, a knocking tool (such as a hammer) is used to knock the head 11 of the nail 1 in order to penetrate the nail end 121 through the planking (not shown) and insert the whole nail 1 therein. For pulling out the nail 1, a tool (such as pneumatic tool) is first inserted into the recess 111 of the head 11 and is used to rotate the head 11 by a torque, so as to bring the nail 1 to rotate back and expose on the planking. Thereafter, a crowbar is used to hold on the head 11 to pry the nail 1 by leverage, such that the nail 1 can be successfully pulled out.

While in operating, the conventional nail has following shortcomings:
1. Due to the reason that the nail 1 has to be nailed back first by the tool, and then pried by the crowbar, it is surely inconvenient and wasting time for the operators; besides, the way to pry the nail by the crowbar is not only labor consuming but easy to damage the surface of the planking, and which causes the planking to be unable to use repeatedly and the resource waste.
2. Due to the reason the conventional nail 1 includes the threads 13 close to the head 11 and merely spirally formed on the shank 12, which means said threads 13 are not spirally formed on the whole shank 12, the threads 13 formed by the upper cutting edge 132 and bottom cutting edge 133 will cause the obstacle during the process of nailing, which lead to the result that the conventional nail 1 has to be pulled out by rotating back via the tool and prying via the crowbar. Therefore, the conventional nail 1 still needs to be improved.

### SUMMARY OF THE INVENTION

An objective of the present invention is to provide a nail that can prevent from damaging the surface of a planking while pulling out the nail and save the time and labor.

Accordingly, the nail of the present invention comprises a head, a shank connected to the head, and a series of umbrella-shaped threads spirally connecting to the shank, wherein the head has a recess formed on the upper surface thereof, the free end of the shank forms a nail end, and the umbrella-shaped threads are extended from the nail end to the head. By abovementioned structure, the nail can be successfully nailed into the planking and directly rotated back from the planking by a tool, and then without prying the nail by any crowbar, the surface of the planking can be prevented from damaging, and thus the time and labor can be efficiently saved. Besides, the planking can be used repeatedly after the nail is pulled out and the resources waste can be highly reduced.

### BRIEF DESCRIPTION OF THE DRAWINGS

The advantages of the present invention over the known prior art will become more apparent to those of ordinary skilled in the art upon reading the following descriptions in conjunction with the accompanying drawings.

FIG. 1 is a perspective view showing a conventional nail;

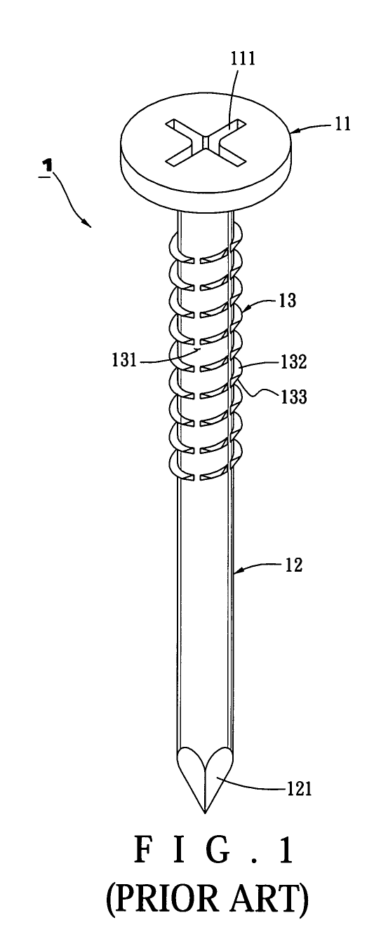

FIG. 2 is a perspective view showing a preferred embodiment of the present invention;

FIG. 3 is a schematic view showing the state of nailing in accordance with the preferred embodiment;

FIG. 4 is a schematic view showing a plurality of the nails arranged in a row;

FIG. 5 is a schematic view showing another state of the nails arranged in a row.

### DETAILED DESCRIPTION OF THE PREFERRED EMBODIMENTS

Before the present invention is described in greater detail, it should be noted that the like elements are denoted by the same reference numerals throughout the disclosure.

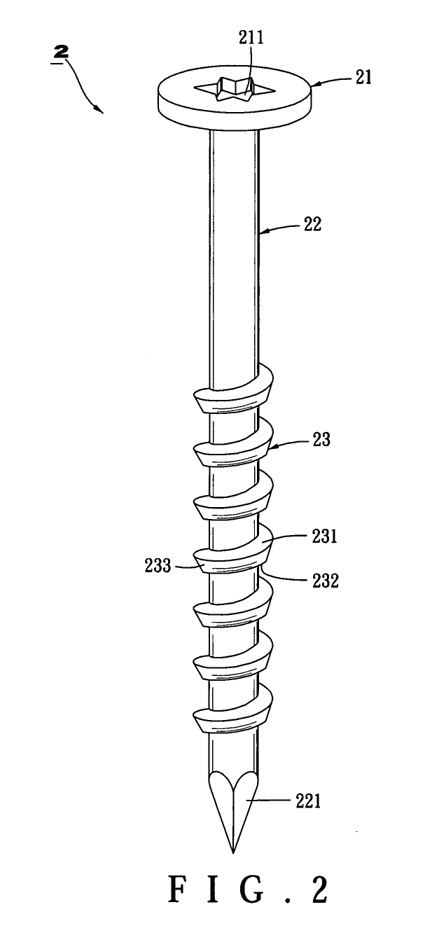

Referring to FIG. 2, a nail 2 in accordance with a preferred embodiment of the present invention comprises a head 21, a shank 22 connecting to the head 21, and a series of umbrella-shaped threads 23 spirally formed on the shank 22. The head 21 has a recess 211 formed on the upper surface thereof, wherein a tool (such as a pneumatic tool) inserts into the recess 211 to rotate the head 21. The recess 211 can be Torx, Slotted, Squared, and it is Torx in the present embodiment. Besides, the shank 22 has a nail end 221 defined on a free end thereof, and the serial umbrella-shaped threads 23 are extended from the nail end 221 to the head 21; wherein, said threads include a top face 231 toward the head 21, an end edge face 232 opposite to the top face 231, and a peripheral face 233 connecting the top face 231 and the end edge face 232, wherein the outer diameter of the top face 231 is greater than the outer diameter of the end edge face 232.

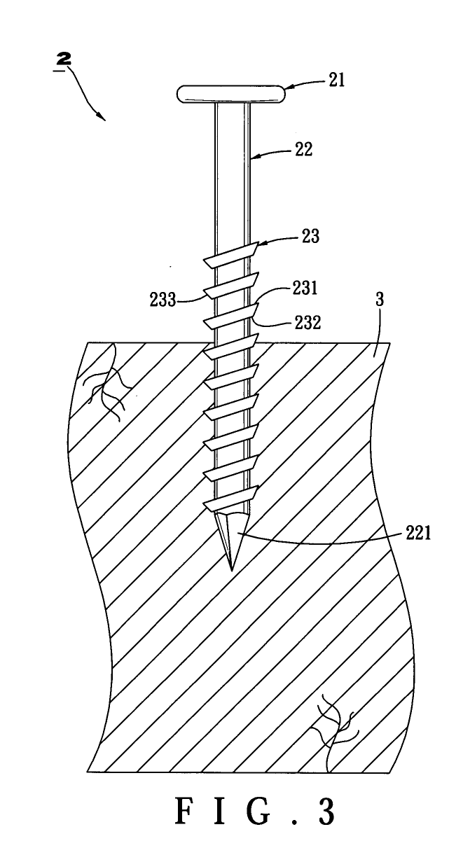

Referring to FIG. 3, while nailing in, a knocking tool (such as a hammer, not shown) is used to knock the head 21 to penetrate the nail end 221 into the planking 3 until the whole nail 2 is merged into the planking 3, so as to achieve the objective of nailing the nail 2 into the planking. During the process of nailing, although the umbrella-shaped threads 23 is formed in series, it will not cause any obstacle because the outer diameter of the top face 231 is greater than the outer diameter of the end edge face 232, which causes the peripheral face 233 connecting the top face 231 and the end edge face 232 to be formed in inclined state, and further accompanying with the height projected out from the umbrella-shaped threads 23 slight greater than the diameter of the shank 22; therefore, the shank 22 can be successfully nailed into the planking 3 without difficulties by the push of the inclined peripheral face 233.

Moreover, while pulling out the nail 2, a tool is directly inserted into the recess 211 for rotating the head 21. Because the umbrella-shaped threads 23 are spirally formed on the shank 22, the nail 2 can be rotated back by the tool, and thereby, the operators can spend less labor and time pulling out the nail 2 from the planking 3 easily, rapidly and successfully. Meanwhile, the surface of the planking 3 can be prevented from damaging and be repeated use, such that the resources waste can be highly reduced.

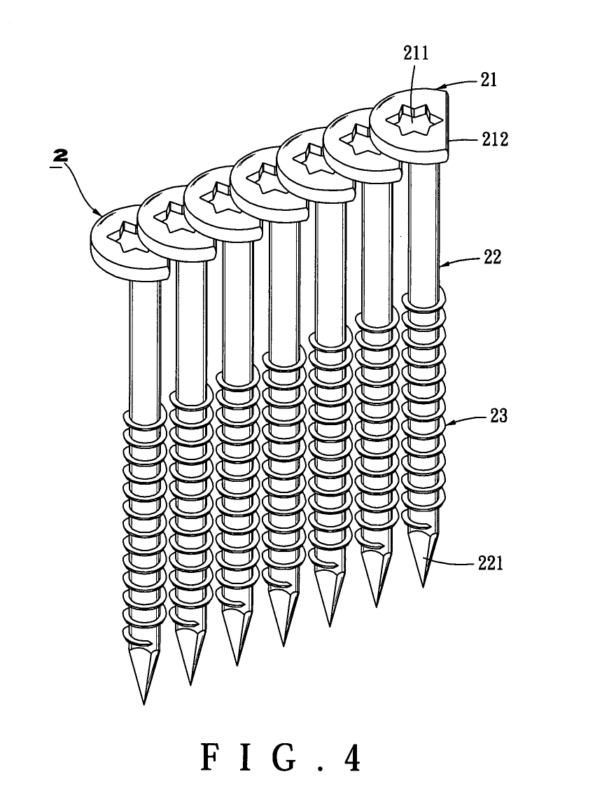

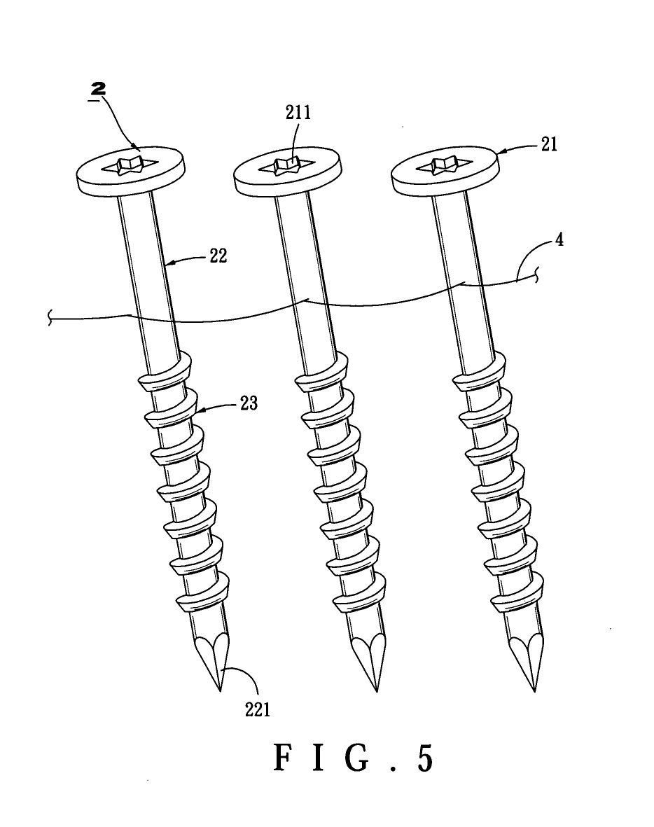

The nails 2 of the present invention can be arranged in a row as shown in FIG. 4 or be arranged in an equal distance and connected by copper line as shown in FIG. 5. No matter what the methods for connecting the nails 2, the operators can use a tool (not shown) for nailing the nail 2 into the planking 3 with less labor. As shown in FIG. 4, wherein the nail 2 is formed in a row state, a portion of the head 21 has to be cut away to form a cutting face 212, and then the cutting face 212 is arranged in the same direction; furthermore, said cutting face 212 is disposed to contact with the shank 22 of the adjacent nail 2 and is put under the head 21 of the adjacent nail 2. Accordingly, the plurality of the nails 2 are arranged as a ladder shape for nailing directly with the tool.

To summarize above, the present invention makes use of the serial umbrella-shaped threads formed on the shank to achieve the time and labor saving and prevent from damaging the surface of the planking while the operator pulls out the nail from the planking; moreover, the planking still can be repeatedly used after pulling the nail out, which highly reduces the resource waste. Besides, the umbrella-shaped threads include a top face toward the head and an end edge face opposite to the top face, and because the outer diameter of the top face is greater than the outer diameter of the end edge face, the peripheral face connecting said top and said end edge face is formed in inclined state; therefore, the umbrella-shaped threads will not cause any obstacle while nailing. Furthermore, because of the push of the inclined peripheral face, the nail can be successfully and easily nailed into the planking, and the present invention can really achieve its purpose.

While we have shown and described the embodiment in accordance with the present invention, it should be clear to those skilled in the art that further embodiments may be made without departing from the scope of the present invention.

I claim:

1. A nail, comprising:
a head having a recess formed on the upper surface thereof, wherein an actuating tool can insert into the recess to rotate the head;
a shank connected to the head at one end and defining a nail end at the other end; and
a series of umbrella-shaped threads spirally formed on the shank and extended from the nail end to the head, and having a top face toward the head, an end edge face opposite to the top face, and a peripheral face connecting the top face and the end edge face, wherein the outer diameter of the top face is greater than the outer diameter of the end edge face.

2. The nail as claimed in claim 1, wherein a plurality of the nails can connect together to form a row of nails, a portion of the head is cut away to form a cutting face on each nail, and the cutting faces are arranged in the same direction and disposed to contact with the shank of the adjacent nail.
